(19) United States
(12) Patent Application Publication
(10) Pub. No.: US 2025/0083358 A1
(43) Pub. Date: Mar. 13, 2025

(54) DIVIDING METHOD

(71) Applicant: DISCO CORPORATION, Tokyo (JP)

(72) Inventors: Masahiro KOBAYASHI, Tokyo (JP); Kazunari TANAKA, Tokyo (JP); Makiko OHMAE, Tokyo (JP)

(21) Appl. No.: 18/816,079

(22) Filed: Aug. 27, 2024

(30) Foreign Application Priority Data
Sep. 12, 2023 (JP) 2023-147657

(51) Int. Cl. B28D 5/02; B28D 5/00

(52) U.S. Cl. CPC B28D 5/022; B28D 5/0005

(57) ABSTRACT

A method is for dividing a plate-like workpiece in which devices are respectively formed in regions sectioned by a plurality of intersecting planned dividing lines. The method includes: forming a first cutting groove not reaching a rear surface of a workpiece by causing a rotating cutting blade to cut into from a front surface of the workpiece along the planned dividing lines; after forming the first cutting groove, forming a second cutting groove not reaching a bottom portion of the first cutting groove by causing the rotating cutting blade to cut into from the rear surface of the workpiece along the first cutting groove; and after forming the second cutting groove, dividing the workpiece along the planned dividing lines by applying external force to the workpiece.

### CROSS-REFERENCE TO RELATED APPLICATION(S)

The present application claims priority to and incorporates by reference the entire contents of Japanese Patent Application No. 2023-147657 filed in Japan on Sep. 12, 2023.

### BACKGROUND

The present disclosure relates to a dividing method of dividing a substrate to be used in an optical device wafer or the like, along a planned dividing line.

An optical device wafer for forming an optical device such as sapphire, silicon carbide (SiC), or glass is commonly divided into individual chips. There has been known a method of dividing an optical device wafer by emitting laser beams to an optical device wafer in the case of dividing an optical device wafer of this type into individual chips, forming a division starting point within the optical device wafer, and then expanding an expanded sheet attached to the optical device wafer (for example, refer to JP 2012-248555 A).

Nevertheless, in the method described in JP 2012-248555 A, in a case where the wafer has a predetermined thickness (e.g., 1 mm), to condense laser beams to the inside of the optical device wafer, a laser beam incidence region in the plane of the optical device wafer needs to be made wide, and the number of chips that can be acquired from one optical device wafer is decreased.

Aside from the above-described method described in JP 2012-248555 A, there is also a method of dividing an optical device wafer by causing a rotating cutting blade to cut into the optical device wafer, but in the method of cutting into an optical device wafer having a predetermined thickness, over multiple times, a processing time increases. Further, in addition to this, in the case of a hard material such as sapphire, because the cutting blade is severely worn and the cost of consumables is incurred, it is uneconomical.

For this reason, a dividing method for solving the above-described problem has been demanded.

### SUMMARY

A method according to one aspect of the present disclosure is for dividing a plate-like workpiece in which devices are respectively formed in regions sectioned by a plurality of intersecting planned dividing lines, and includes: forming a first cutting groove not reaching a rear surface of a workpiece by causing a rotating cutting blade to cut into from a front surface of the workpiece along the planned dividing lines; after forming the first cutting groove, forming a second cutting groove not reaching a bottom portion of the first cutting groove by causing the rotating cutting blade to cut into from the rear surface of the workpiece along the first cutting groove; and after forming the second cutting groove, dividing the workpiece along the planned dividing lines by applying external force to the workpiece.

### BRIEF DESCRIPTION OF THE DRAWINGS

FIG. 1 is a perspective view illustrating an example of a workpiece to be processed in a dividing method according to a first embodiment;

FIG. 2 is a flowchart illustrating a flow of the dividing method according to the first embodiment;

FIG. 3 is a perspective view schematically illustrating a state of attaching a dicing tape to the rear surface of the workpiece in a first cutting step of the dividing method illustrated in FIG. 2;

FIG. 4 is a perspective view schematically illustrating a state in which the dicing tape is attached to the rear surface of the workpiece in the first cutting step of the dividing method illustrated in FIG. 2;

FIG. 5 is a perspective view schematically illustrating a state of forming a first cutting groove on the front surface of the workpiece in the first cutting step of the dividing method illustrated in FIG. 2;

FIG. 6 is a perspective view schematically illustrating a state of forming a second cutting groove on the rear surface of the workpiece in a second cutting step of the dividing method illustrated in FIG. 2;

FIG. 7 is a side view schematically illustrating, as a partial cross-section, a state in which the workpiece is held on a dividing apparatus in a dividing step of the dividing method illustrated in FIG. 2; and

FIG. 8 is a side view schematically illustrating, as a partial cross-section, a state in which the workpiece is divided into individual chips in the dividing step of the dividing method illustrated in FIG. 2.

### DETAILED DESCRIPTION

An embodiment according to the present disclosure will be described in detail with reference to the drawings. The present invention is not limited by the description in the following embodiment. Further, the components to be described below include those that can be readily conceived by those skilled in the art, and those that are substantially the same. Furthermore, the configurations to be described below can be appropriately combined. Further, various omissions, substitutions, or changes of the configuration can be made without departing from the gist of the present invention.

### First Embodiment

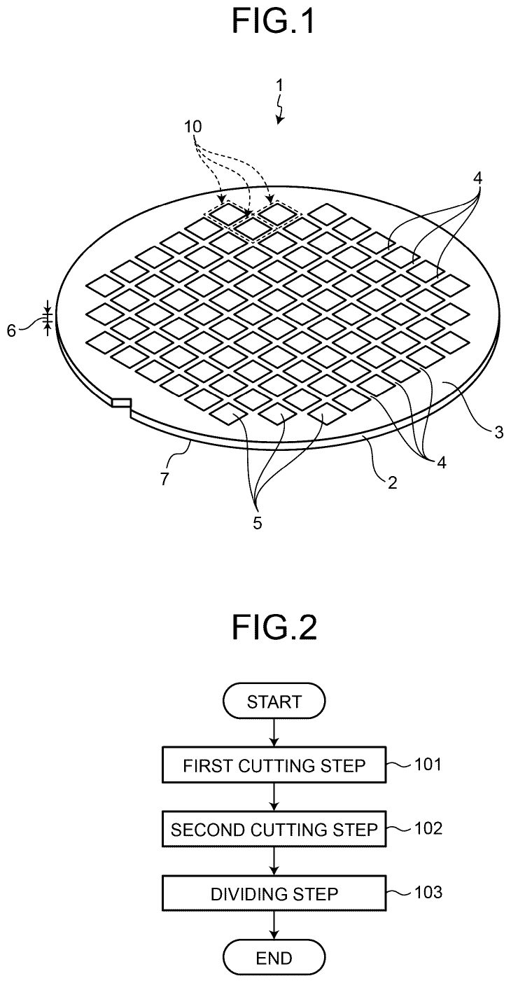

A dividing method according to the first embodiment of the present disclosure will be described based on the drawings. FIG. 1 is a perspective view illustrating an example of a workpiece to be processed in the dividing method according to the first embodiment. FIG. 2 is a flowchart illustrating a flow of the dividing method according to the first embodiment.

### Workpiece

The dividing method according to the first embodiment is a method of dividing a workpiece 1 illustrated in FIG. 1, into individual device chips 10. The workpiece 1 to be processed in the dividing method according to the first embodiment is a wafer such as a disc-shaped optical device wafer that uses, for example, sapphire, silicon carbide (SiC), or glass as a substrate 2. That is, in the first embodiment, the workpiece 1 includes, as the substrate 2, a sapphire substrate, a SiC substrate, or a glass substrate. In the first embodiment, because the substrate 2 of the workpiece 1 is made of sapphire, SiC, or glass, the substrate 2 is harder than, for example, silicon constituting a substrate of a semiconductor wafer, that is to say, a silicon substrate.

As illustrated in FIG. 1, in the workpiece 1, a plurality of planned dividing lines 4 intersecting with each other is set on a front surface 3 of the substrate 2, and devices 5 are respectively formed in regions sectioned by the planned dividing lines 4 on the front surface 3 of the substrate 2. In the first embodiment, the devices 5 are optical devices such as, for example, light-emitting diodes (LEDs).

The workpiece 1 is divided into the individual device chips 10 along the planned dividing lines 4. The device chips 10 include a part of the substrate 2, and the devices 5 formed on the front surface 3 of the substrate 2. Further, a thickness 6 of the workpiece 1 is from 750 μm to 1 mm both inclusive and thicker than a semiconductor wafer in which the substrate 2 is made of silicon or the like. In addition, in the first embodiment, the thickness 6 of the workpiece 1 is 750 μm.

### Dividing Method

The dividing method according to the first embodiment is a method of dividing the workpiece 1 into the individual device chips 10 along the planned dividing lines 4. The device chips 10 include a part of the substrate 2, and the devices 5 formed on the front surface of the substrate 2. As illustrated in FIG. 2, the dividing method according to the first embodiment includes a first cutting step 101, a second cutting step 102, and a dividing step 103.

### First Cutting Step

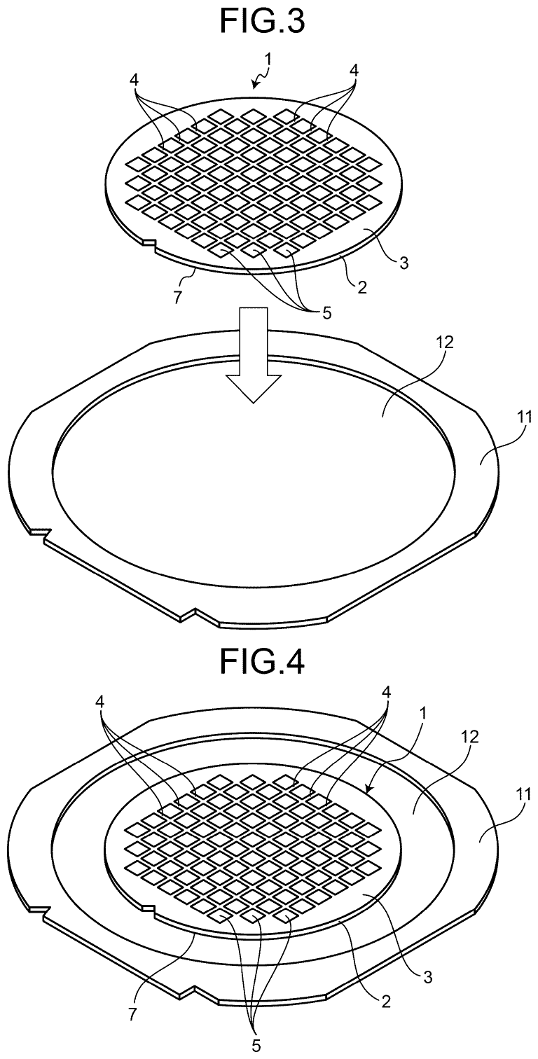

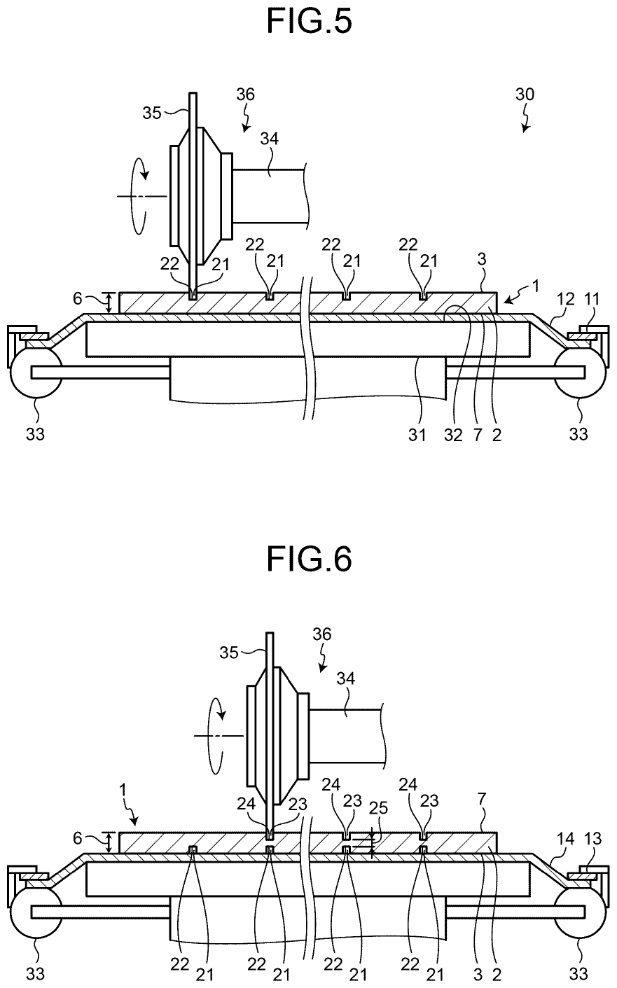

FIG. 3 is a perspective view schematically illustrating a state of attaching a dicing tape to the rear surface of the workpiece in the first cutting step of the dividing method illustrated in FIG. 2. FIG. 4 is a perspective view schematically illustrating a state in which the dicing tape is attached to the rear surface of the workpiece in the first cutting step of the dividing method illustrated in FIG. 2. FIG. 5 is a perspective view schematically illustrating a state of forming a first cutting groove on the front surface of the workpiece in the first cutting step of the dividing method illustrated in FIG. 2.

The first cutting step 101 is a step of causing a rotating cutting blade 35 to cut into from the front surface 3 of the workpiece 1 along the planned dividing lines 4, and forming a first cutting groove 21 not reaching a rear surface 7 on the back side of the front surface 3 of the workpiece 1. In the first embodiment, in the first cutting step 101, as illustrated in FIG. 3, a disc-shaped dicing tape 12 having a larger outer diameter than an outer diameter of the workpiece 1, and having an outer rim portion to which an annular frame 11 having an inner diameter larger than the outer diameter of the workpiece 1 is attached is opposed to the rear surface 7 on the back side of the front surface 3 of the workpiece 1.

In the first embodiment, in the first cutting step 101, as illustrated in FIG. 4, the rear surface 7 of the workpiece 1 is attached to a central portion of the dicing tape 12, and the workpiece 1 is supported in an opening inside the annular frame 11 via the dicing tape 12. In addition, in the first embodiment, the dicing tape 12 is an adhesive tape including a base layer made of non-adhesive and flexible resin, and a glue layer stacked on the base layer and made of adhesive and flexible resin, in which the glue layer is attached to the rear surface 7 of the workpiece 1. Further, in the present disclosure, the dicing tape 12 may be a sheet that includes only a base material made of thermoplastic resin, without including a glue layer, and is to be attached to the rear surface 7 of the workpiece 1 and the annular frame 11 by being heated.

In the first embodiment, in the first cutting step 101, a cutting apparatus 30 illustrated in FIG. 5 sucks and holds the rear surface 7 side of the substrate 2 of the workpiece 1 on a holding surface 32 of a chuck table 31 via the dicing tape 12, and nips the annular frame 11 in a clamp portion 33 existing around the chuck table 31. In the first embodiment, in the first cutting step 101, as illustrated in FIG. 5, while relatively moving the chuck table 31 and the cutting blade 35 rotating around an axis center by a spindle 34 of a cutting unit 36, along the planned dividing lines 4, the cutting apparatus 30 causes the cutting blade 35 to cut into a depth not reaching the rear surface 7, from the front surface 3 of the workpiece 1, and forms the first cutting groove 21 not reaching the rear surface 7 (i.e. a bottom portion 22 positioned at the center in a thickness direction of the workpiece 1), on the front surface 3 of the workpiece 1 along the planned dividing lines 4. In the first embodiment, in the first cutting step 101, the cutting apparatus 30 forms the first cutting grooves 21 on the front surface 3 of the workpiece 1 along all the planned dividing lines 4.

### Second Cutting Step

FIG. 6 is a perspective view schematically illustrating a state of forming a second cutting groove on the rear surface of the workpiece in the second cutting step of the dividing method illustrated in FIG. 2. The second cutting step 102 is a step of causing the rotating cutting blade 35 to cut into along the first cutting groove 21 from the rear surface 7 of the workpiece 1, and forming a second cutting groove 23 not reaching the bottom portion 22 of the first cutting groove 21, after the first cutting step 101.

In the first embodiment, in the second cutting step 102, the dicing tape 12 is peeled off from the rear surface 7 of the workpiece 1. In the first embodiment, in the second cutting step 102, a central portion of a disc-shaped dicing tape 14 (different from the dicing tape 12) having a larger outer diameter than the outer diameter of the workpiece 1, and having an outer rim portion to which an annular frame 13 (different from the annular frame 11) having an inner diameter larger than the outer diameter of the workpiece 1 is attached is attached to the front surface 3 of the workpiece 1, and the workpiece 1 is supported in an opening inside the annular frame 13 via the dicing tape 14.

In addition, in the first embodiment, similarly to the dicing tape 12, the dicing tape 14 is an adhesive tape including a base layer made of non-adhesive and flexible resin, and a glue layer stacked on the base layer and made of adhesive and flexible resin, in which the glue layer is attached to the front surface 3 of the workpiece 1. Further, in the present disclosure, the dicing tape 14 may be a sheet that includes only a base material made of thermoplastic resin, without including a glue layer, and is to be attached to the front surface 3 of the workpiece 1 and the annular frame 13 by being heated.

In the first embodiment, in the second cutting step 102, the cutting apparatus 30 illustrated in FIG. 6 sucks and holds the front surface 3 side of the substrate 2 of the workpiece 1 on the holding surface 32 of the chuck table 31 via the dicing tape 14, and nips the annular frame 13 in the clamp portion 33. In the first embodiment, in the second cutting step 102, as illustrated in FIG. 6, while relatively moving the chuck table 31 and the cutting blade 35 rotating around the axis center by the spindle 34 of the cutting unit 36, along the planned dividing lines 4, the cutting apparatus 30 causes the cutting blade 35 to cut into a depth not reaching the bottom portion 22 of the first cutting groove 21, from the rear surface 7 of the workpiece 1, and forms the second cutting groove 23 not reaching the bottom portion 22 of the first cutting groove 21 (i.e. a bottom portion 24 positioned at the center in the thickness direction of the workpiece 1), on the rear surface 7 of the workpiece 1 along the first cutting groove 21. In the first embodiment, in the second cutting step 102, the cutting apparatus 30 forms the second cutting grooves 23 on the rear surface 7 of the workpiece 1 along the first cutting grooves 21 formed along all the planned dividing lines 4.

Further, in the first embodiment, a distance 25 between the bottom portion 22 of the first cutting groove 21 and the bottom portion 24 of the second cutting groove 23 that are formed in the cutting steps 101 and 102 is equal to or smaller than 1/10 of the thickness 6 of the workpiece 1. Further, in the first embodiment, the distance 25 between the bottom portion 22 of the first cutting groove 21 and the bottom portion 24 of the second cutting groove 23 that are formed in the cutting steps 101 and 102 is desirably equal to or larger than 30/750 of the thickness 6 of the workpiece 1.

### Dividing Step

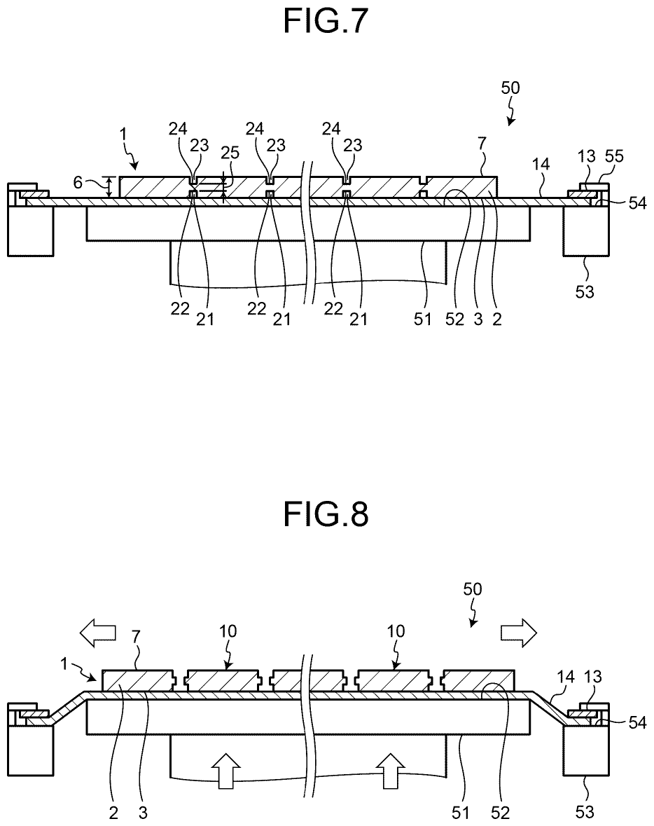

FIG. 7 is a side view schematically illustrating, as a partial cross-section, a state in which the workpiece is held on the dividing apparatus in the dividing step of the dividing method illustrated in FIG. 2. FIG. 8 is a side view schematically illustrating, as a partial cross-section, a state in which the workpiece is divided into individual chips in the dividing step of the dividing method illustrated in FIG. 2.

The dividing step 103 is a step of dividing the workpiece 1 along the planned dividing lines 4 by applying external force to the workpiece 1 after the second cutting step 102. In the first embodiment, in the dividing step 103, as illustrated in FIG. 7, in a dividing apparatus 50, the front surface 3 side of the workpiece 1 is placed via the dicing tape 14 on a holding surface 52 of a holding table 51, and the annular frame 13 is placed on a top surface 54 of a placing plate 53 provided on the outer periphery of the holding table 51 via the outer rim portion of the dicing tape 14. At this time, the holding surface 52 of the holding table 51 and the top surface 54 of the placing plate 53 are positioned on the same plane. In the first embodiment, in the dividing step 103, the dividing apparatus 50 nips the annular frame 13 between the top surface 54 of the placing plate 53 in a clamp portion 55.

In the first embodiment, in the dividing step 103, the dividing apparatus 50 relatively moves the holding table 51 and the placing plate 53 in a direction orthogonal to the holding surface 52, that is to say, the front surface 3 of the workpiece 1 placed on the holding table 51. In the first embodiment, in the dividing step, as illustrated in FIG. 8, the dividing apparatus 50 raises the holding table 51, and expands the dicing tape 14 in a plane direction.

Accordingly, as a result of the expansion of the dicing tape 14, tensile force radially acts on the dicing tape 14, and radial tensile force being external force is applied to the workpiece 1 from the dicing tape 14. In the first embodiment, in the dividing step 103, because the cutting grooves 21 and 23 are formed along the planned dividing lines 4, if radial tensile force is applied as external force, as illustrated in FIG. 8, the workpiece 1 is divided into the individual device chips 10 starting from the cutting grooves 21 and 23, and intervals between the device chips 10 are widened. After that, the device chips 10 are picked up from the dicing tape 14.

The above-described dividing method according to the first embodiment forms the first cutting groove 21 on the front surface 3 side in the first cutting step 101, and forms the second cutting groove 23 not reaching the bottom portion 22 of the first cutting groove 21, on the rear surface 7 side in the second cutting step 102. For this reason, the dividing method according to the first embodiment can suppress a cutting amount by which the workpiece 1 is cut, and suppress the number of times the workpiece 1 is cut, and a wear amount of the cutting blade 35.

Further, the dividing method according to the first embodiment divides the workpiece 1 into the individual device chips 10 by applying external force to the workpiece 1 after the cutting steps 101 and 102.

Consequently, the dividing method according to the first embodiment can bring about an effect of being able to smoothly divide the workpiece 1 while suppressing a processing time and cost, even if the workpiece 1 is harder than that including a silicon substrate including a sapphire substrate, a SiC substrate, or a glass substrate, as the substrate 2, or even if the thickness 6 is thicker than a semiconductor wafer with the thickness of 750 μm or more.

Further, because the dividing method according to the first embodiment forms the cutting grooves 21 and 23 as division starting points in the dividing step 103, the dividing method does not emit laser beams when forming the division starting points.

Consequently, the dividing method according to the first embodiment can suppress an increase in width of the planned dividing lines 4, and prevent the number of device chips 10 that can be acquired from the workpiece 1, from decreasing, even if the thickness of the workpiece 1 is thicker than a semiconductor wafer with the thickness of 750 μm or more.

To suppress a cutting amount to be employed by the cutting blade 35, the above-described distance 25 between the bottom portions 22 and 24 of the cutting grooves 21 and 23 is desired to be made longer, but if the distance 25 is made too long, the planned dividing line 4 not used in dividing is generated after the dividing step 103. In view of the foregoing, the inventor(s) checked the effect of the dividing method according to the first embodiment. The result is show in Table 1 given below.

In the checking, dividing statuses caused after the workpieces 1 of Comparative Example, Inventive Product 1, Inventive Product 2, and Inventive Product 3, in which the distances 25 between the bottom portions 22 and 24 of the cutting grooves 21 and 23 are different, the substrate 2 is made of sapphire, and the thickness 6 is 750 μm, are divided in the dividing step 103 were checked. In addition, in Table 1, a circle is allocated to a dividing status of an example in which dividing was executed along all the planned dividing lines 4, and a cross mark is allocated to a dividing status of an example in which dividing was not executed along at least a part of the planned dividing lines 4.

TABLE 1

| | | Dividing |
|---|---|---|
| | Distance | Status |
| Inventive Product 1 | 30 μm | ◯ |
| Inventive Product 2 | 50 μm | ◯ |
| Inventive Product 3 | 75 μm | ◯ |
| Comparative Example | 90 μm | X |

In Comparative Example, the distance 25 was set to 90 μm. In Inventive Product 1, the distance 25 was set to 30 μm. In Inventive Product 2, the distance 25 was set to 50 μm. In Inventive Product 3, the distance 25 was set to 75 μm.

According to Table 1, in Comparative Example, dividing was not executed along a part of the planned dividing lines 4. In contrast to such a comparative example, in Inventive Product 1, Inventive Product 2, and Inventive Product 3, dividing was executed along all the planned dividing lines 4.

Thus, according to Table 1, it was revealed that, by setting the distance 25 between the bottom portions 22 and 24 of the cutting grooves 21 and 23 that are formed in the cutting steps 101 and 102, to a distance equal to or larger than 30/750 and equal to or smaller than 1/10 of the thickness 6 of the workpiece 1, it is possible to divide the workpiece 1 into the individual device chips 10 while suppressing a cutting amount by which the workpiece 1 is cut, and suppressing the number of times the workpiece 1 is cut, and a wear amount of the cutting blade 35, even if the workpiece 1 is harder than that including a silicon substrate including a sapphire substrate, a SiC substrate, or a glass substrate, as the substrate 2, or even if the thickness 6 of the workpiece 1 is thicker than a semiconductor wafer with the thickness of 750 μm or more.

In short, according to Table 1, it was revealed that, by setting the distance 25 between the bottom portions 22 and 24 of the cutting grooves 21 and 23 to a distance equal to or larger than 30/750 and equal to or smaller than 1/10 of the thickness 6 of the workpiece 1, it is possible to smoothly divide the workpiece 1 while suppressing a processing time and cost, even if the workpiece 1 is harder than that including a silicon substrate including a sapphire substrate, a SiC substrate, or a glass substrate, as the substrate 2, or even if the thickness 6 of the workpiece 1 is thicker than a semiconductor wafer with the thickness of 750 μm or more.

According to the present disclosure, it is possible to smoothly divide a workpiece while suppressing a processing time and cost.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A method for dividing a plate-like workpiece in which devices are respectively formed in regions sectioned by a plurality of intersecting planned dividing lines, the method comprising:
forming a first cutting groove not reaching a rear surface of a workpiece by causing a rotating cutting blade to cut into from a front surface of the workpiece along the planned dividing lines;
after forming the first cutting groove, forming a second cutting groove not reaching a bottom portion of the first cutting groove by causing the rotating cutting blade to cut into from the rear surface of the workpiece along the first cutting groove; and
after forming the second cutting groove, dividing the workpiece along the planned dividing lines by applying external force to the workpiece.

2. The method according to claim 1, wherein a distance between the bottom portion of the first cutting groove and a bottom portion of the second cutting groove is equal to or smaller than 1/10 of a thickness of the workpiece.

3. The method according to claim 1, wherein the workpiece includes a sapphire substrate, a silicon carbide (SiC) substrate, or a glass substrate.
